(19) United States
(12) Patent Application Publication
(10) Pub. No.: US 2010/0121844 A1
(43) Pub. Date: May 13, 2010

(54) IMAGE RELEVANCE BY IDENTIFYING EXPERTS

(75) Inventors: Malcolm Slaney, Sunnyvale, CA (US); Srinivasan H. Sengamedu, Bangalore (IN)

Correspondence Address: MPG, LLP AND YAHOO! INC., 710 LAKEWAY DRIVE, SUITE 200, SUNNYVALE, CA, 94085, US

(73) Assignee: YAHOO! INC., Sunnyvale, CA (US)

(21) Appl. No.: 12/266,939

(22) Filed: Nov. 7, 2008

(51) Int. Cl. G06F 17/30; G06F 7/00

(52) U.S. Cl. 707/723; 707/E17.017

(57) ABSTRACT

A method of generating a list of ranked media-content search results is presented. The method begins with a plurality of links to media-content being collected and the media content is grouped by originating site. A query for media-content is initiated when a keyword is received. The media-content from each originating site or subsite receives a tag-specific ranking. Each grouping of media-content is ranked based on external-based metrics and quality-based metrics. Quality-based metrics are defined by calculating a percentage of the media-content of each grouping that is associated with the keyword, the quality of the media content, relevance of the text associated with each media-content to the keyword, and other measurements. A relative weighting between external-based metrics and quality-based metrics is established for each grouping of media-content. A list of ranked media-content search results based on the relative weighting between external-based metrics and quality-based metrics are stored on the system.

### BACKGROUND OF THE INVENTION

It is very difficult for image searches to return results with a high degree of relevance. Conventional web searches use metrics such as page rank, based on links that people make to different content, to infer relevance and expertise. Image searches, on the other hand, are unable to exploit this characteristic since images are not linked to each other. Another drawback of the current image-searching methods is each image on a website is considered independently of the other images on the same website. Thus each image on a site with many high-quality images is not given any benefit based on the editorial judgments that go into the site design.

In contrast to conventional web searches, image searches involve indexing the text around images and storing the index in a large database. When an image query is made a search is conducted on the database containing the image indices to generate the image search results. Other than analyzing the text around images, there is little indication of which images are most relevant for a particular image search. This is especially true for website containing large collections of images, which often have few intra-photo links.

It is in this context that embodiments of the invention arise.

### SUMMARY OF THE INVENTION

Broadly speaking, the present invention fills these needs by providing a method and apparatus for generating relevant search results. It should be appreciated that the present invention can be implemented in numerous ways, including as a method, a system, or a device. Several inventive embodiments of the present invention are described below.

In accordance with one aspect of the invention, a method of generating a list of ranked media-content search results is provided. The method begins with a plurality of links to media-content being collected and the media content is grouped by originating site. A query for media-content is initiated when a keyword is received. The media-content from each originating site or subsite receives a tag-specific ranking. Each grouping of media-content is ranked based on external-based metrics and quality-based metrics. Quality-based metrics are defined by calculating a percentage of the media-content of each grouping that is associated with the keyword, the quality of the media content, relevance of the text associated with each media-content to the keyword, and other measurements. A relative weighting between external-based metrics and quality-based metrics is established for each grouping of media-content. The list of ranked media-content search results based on the relative weighting between external-based metrics and quality-based metrics are stored on the system.

In accordance with another aspect of the invention, a system for generating relevant image-searches is detailed. The server system collects links to plurality of images associated with the keyword and consolidates the plurality of images into groups. A user initiates an image-search query to a server system in communication with the client system through an Internet connection. Each of the groups receives a tag-specific ranking. The server system includes an external-rank module which ranks each group of images based on external-based metrics and a quality-rank module ranking each cluster of images based on quality-based metrics. The expertise-rank module produces rankings by calculating a percentage of images of each grouping associated with the keyword, quality of the plurality of images, and relevance of the text associated with each image to the keyword. The server system further includes a tag-specific rank module to compute a tag-specific ranking for each group of images using results from the external-rank module and the quality-rank module. Image-search results are provided by the server system based on the tag-specific ranking of each grouping of images. A listing of ranked image-search results is stored on the server system.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 illustrates a system 10 to generate relevant image-searches in accordance with one embodiment of the present invention.

FIG. 2 illustrates the composition of the quality-based metrics and the external-based metrics in accordance with one embodiment of the present invention.

FIG. 3 illustrates calculation of a tag-specific ranking for each content group in a content-sharing website in accordance with one embodiment of the present invention.

FIG. 4 illustrates limiting the image-search results from each originating site to a single image in accordance with one embodiment of the present invention.

FIG. 5 is flow chart diagram illustrating process operations for generating a list of ranked media-content search results in accordance with one embodiment of the present invention.

### DETAILED DESCRIPTION

The following embodiments describe an apparatus and method for generating relevant image-search results. It will be obvious, however, to one skilled in the art, that the present invention may be practiced without some or all of these specific details. In other instances, well known process operations have not been described in detail in order not to unnecessarily obscure the present invention.

When image-searches are unable to take advantage of mechanisms such as page rank to measure the relevance of an image search result, image-search results can be enhanced by modeling the expertise of various collections of images. Many of the images stored online are organized in collections, such as a content group on a content-sharing website or a photo-rich website. In one embodiment, a process is performed to measure the relevance of image collections to produce data that enhances image-search quality and experience.

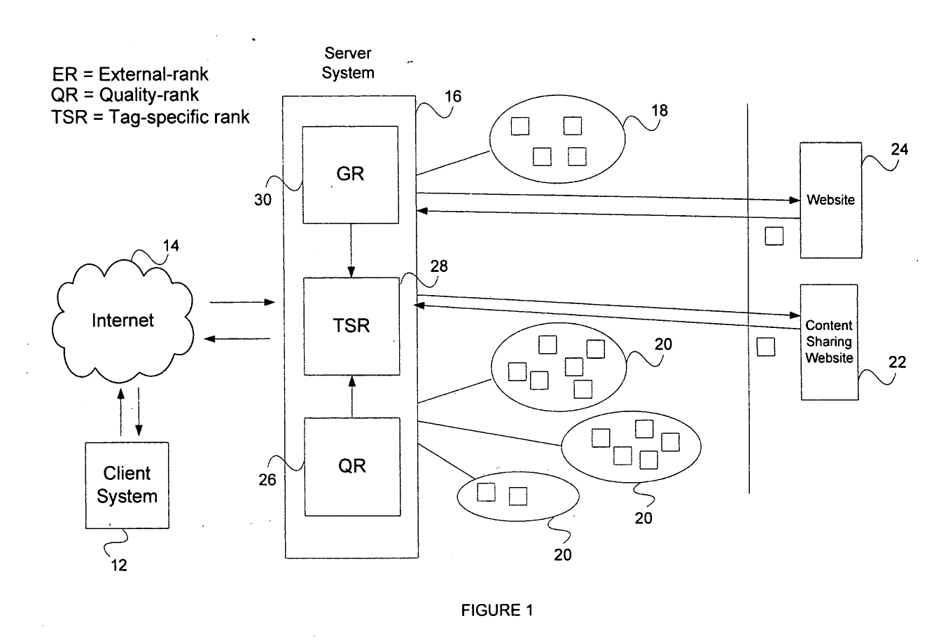

FIG. 1 illustrates a system 10 to generate relevant image searches in accordance with one embodiment of the present invention. A user accesses a client system 12 to initiate an image-search query using a keyword or a keyword string. The image-search request is transmitted to a server system 16 which is in communication with the client system 12 through an Internet connection 14. The server system 16 collects links to a plurality of images 18 and 20 associated with the keyword from a plurality of sources 22 and 24 through the Internet 14.

The server system 16 consolidates images from each source 22 and 24 into groups of images 18 and 20, where images from each source receive a tag-specific ranking. In one embodiment, sources of image include one or more of a single webpage, a standalone website, a logically linked set of images and pages of a content-sharing website, or a set of web pages all hosted in the same part of a domain (e.g. madonna.people.com). For a content sharing site 22 (e.g. Flickr™, YouTube™, etc.), where content is provided by a plurality of users and may be organized into groups of images or content groups 20 and each group of images (content group) 20 is considered a source of images for the purpose of ranking the relevance. For standalone websites 24 (e.g. ESPN.com™, CNN.com™, etc.), all the images 18 as a whole are considered to be a single source of images when ranking the relevance of the standalone website 24. Specific websites are cited for illustrative purposes, and as such do not limit the scope of the present invention.

The server system 16 includes a external-rank module 30, which computes the ranking each group of images 18 and 20 based on external-based metrics. The external-rank module 30 analyzes external-based metrics associated with each group of images 18 and 20 to provide input to the tag-specific rank module 28. The server system 16 further includes a quality-rank module 26, which analyzes various metrics associated with the group of images 18 and 20 as well as the images to provide input to the tag-specific rank module 28.

Input from the external-rank module 30 and the quality-rank module 26 is provided to the tag-specific rank module 28 to compute a tag-specific ranking for each group of images 18 and 20. The tag-specific ranking is a measure of the relevance the group of images 18 and 20 has to the image search. In one embodiment, the tag-specific rank module 28 uses a multiplicative model to determine the tag-specific ranking and the relative weighting between the external-based metrics and the quality-based metrics is assigned by inspection. In another embodiment, the relative weighting between the external-based metrics and the quality-based metrics is determined using machine-learning techniques which give the best match in expertise between the weighted sum of the quality measures and human-judgments of quality of the image search.

The server system 16 stores the image-search results and returns the image-search results to the client system 12 based on the tag-specific ranking of each grouping of images from the tag-specific rank module 28 of the server system 16. A predetermined number of images are presented to the user through the client system 12, where the images presented have the highest tag-specific ranking from the tag-specific rank module 28 of the server system 16. The client system 12 receives image-search results from the server system 16, which are displayed on a display of the client system 12.

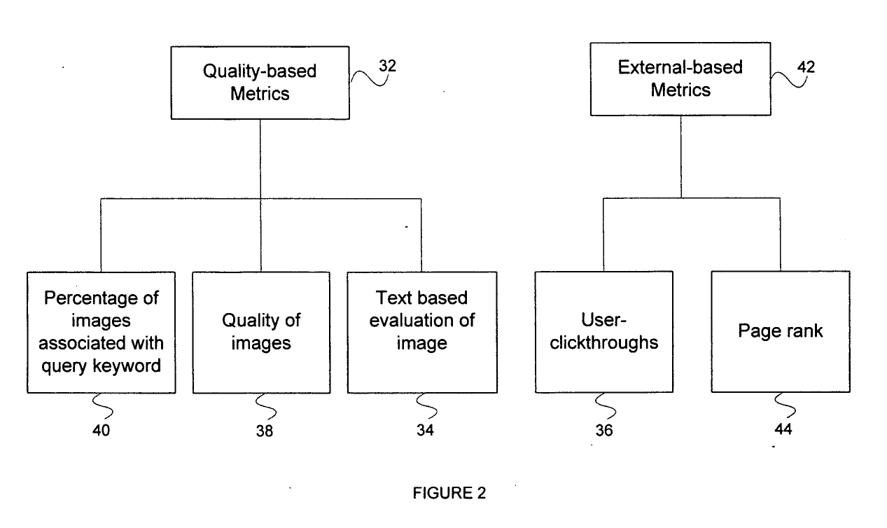

FIG. 2 illustrates the composition of the quality-based metrics and the external-based metrics in accordance with one embodiment of the present invention. Each group of images is provided a tag-specific ranking based on the expertise of each group of images. In one embodiment, the expertise of a group of images is a weighted function of quality-based metrics 32 and external-based metrics 42. The external-rank module in the server system ranks each cluster of images based on external-based metrics 42. In another embodiment, external-based metrics 42 consists of one or more of tracking a number of user click-throughs 36 of each of the plurality of images and the page rank 44 of the webpages containing the images.

In one embodiment, a number of user click-throughs 36 to each image is tracked. A user click-through 36 is when a user clicks on a particular image-search result. Images which receive a large number of user click-throughs 36 for a particular image search receive a higher external-based metric 42 ranking than images which receive fewer user click-throughs 36. In yet another embodiment, external-based metrics 42 includes tracking the number of times a user bookmarks an image for a particular image search.

Tracking user click-throughs 36 reduces false positive results from someone intentionally manipulating the expertise criteria to artificially increase the likelihood for a particular cluster of images to be returned in a particular image search. As an example, such a person could generate a large number of non-relevant images, associate these images with a keyword such as “Madonna”, and receive a high external-based ranking. Tracking the number of user click-throughs 36 as part of the tag-specific ranking will reduce the success of this spamming technique.

In one embodiment, page rank 44 is defined by measures such as the HITS algorithm or Google's PageRank™. The HITS algorithm determines a page rank 44 for a webpage based on two values: its authority, which estimates the value of the content of the page, and its hub value, which estimates the value of its links to other pages. Further details on the HITS algorithm may be found in “Authoritative Sources in a Hyperlinked Search” by Jon M. Kleinberg, IBM Research Report, May 1997. This article is incorporated by reference for all purposes. In another embodiment, the page rank can be the average page rank for the website.

Quality-based metrics 32 are calculated by the quality-rank module of the server system. The quality-rank module produces rankings by calculating one or more of a percentage 40 of images associated with the keyword, the quality of the plurality of images 38, and the relevance of the text 34 on the webpage to a textual query. A cluster of images with a high percentage of images associated with the keyword for particular image-search indicates the cluster of images has a high degree of relevancy for that particular image-search. In one embodiment, the quality-rank module calculates the percentage 40 of images associated with the keyword based on the metadata (e.g. filename) associated with the image matching the keyword.

In one embodiment, the quality-rank module analyzes the quality of the plurality of images 38 including one or more of measuring sharpness, histogram equalization, and the compression ratio of each of the plurality of images. A high degree of image sharpness and histogram equalization (contrast) indicates the cluster of images is desirable for image-searches. In another embodiment, the quality-rank module calculates a quality ranking based on the spatial distribution of edges, color distribution, hue count, blur, and low level features of each image. Further details may be found in “The Design of High-Level Features for Photo Quality Assessment” by Yan Ke et al., Proceedings of the 2006 IEEE Computer Society Conference on Computer Vision and Pattern Recognition, pages 419-426. This article is incorporated by reference for all purposes.

In one embodiment, relevance of the text 36 on the webpage checks if the filename of each of the images matches the keyword associated with the image-search. An image with a filename matching the keyword would indicate a high degree relevancy to the particular image-search. In yet another embodiment, the quality-rank module measures the proximity of text associated with each of the plurality of images matches the keyword used in the image search query. Text associated with each of the images that is located closer to the beginning of the text which matches the keyword is weighed more heavily than text that matches that occur toward the end of the text. For example, if the section heading associated with a first image matches the keyword, the first image would receive a higher ranking than a second image where the tenth word of a sentence after the second image matches the keyword. Specific metrics are cited for illustrative purposes, and as such do not limit the scope of the present invention.

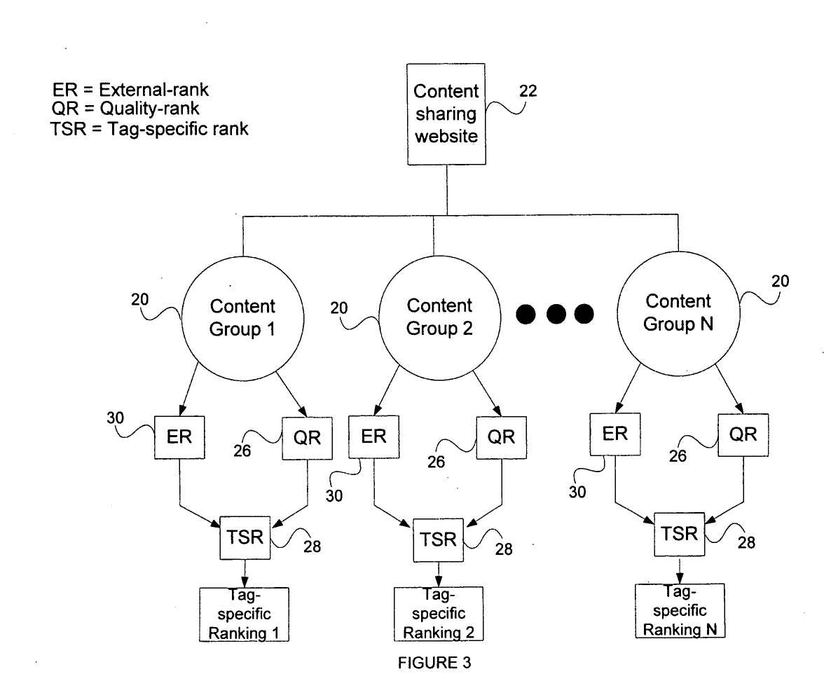

In a content-sharing website hosting a large number of random images provided by users, one can envision it would be difficult for the content-sharing site as a whole to receive a high expertise ranking for any particular query due to the fact the percentage of the images on the content-sharing website being relevant to any particular image-search will be low. FIG. 3 illustrates calculation of a tag-specific ranking for each content group in a content-sharing website in accordance with one embodiment of the present invention. By ranking the other images on the content-sharing website 22 by the content group 20, the relevance of a particular content group 22 can be evaluated without being influenced by the many images on the content-sharing website 22 that are irrelevant to the particular image-search.

The server system separately evaluates each of the content groups 20 in the content-sharing website 22, assuming each content group 20 is a separate source of images. When the tag-specific rank module 28 in the server system calculates a tag-specific ranking, each of the plurality of content groups 20 in a content-sharing website 22 is considered as a separate source and is separately evaluated by the quality-rank module 26 and the external-rank module 30 of the server system. Each content group 20 receives a tag-specific ranking 44 independent of the tag-specific ranking 44 of the other content groups 20 on the content-sharing website 22. Results from the image-search returned to the client system by the server system are based on the tag-specific ranking 44 of each content group 20 of the content-sharing website 22.

In one embodiment, the tag-specific rank module 30 calculates the tag-specific ranking 44 as a weighted sum of the inputs from the quality-rank module 26 and the external-rank module 30. A tag-specific ranking (TSR) 44 with five metrics can be written as:

TSR=a×q_{—}i+b×q_{—}q+c×q_{—}t+d×e_{—}c+e×e_{—}f (1),

where a, b, c, d, and e are independent weights for the metrics: percentage of images associated with the keyword, the quality of the plurality of images, the relevance of the text on the webpage to a textual query, the number of user click-throughs, and the page rank of the webpage respectively. In yet another embodiment, the tag-specific ranking 44 can be written as a non-linear function of the quality-metrics and the expertise-metrics, where independent weights are determined using machine-learning techniques such as support vector machines (SVM), gradient boosted decision trees, etc.

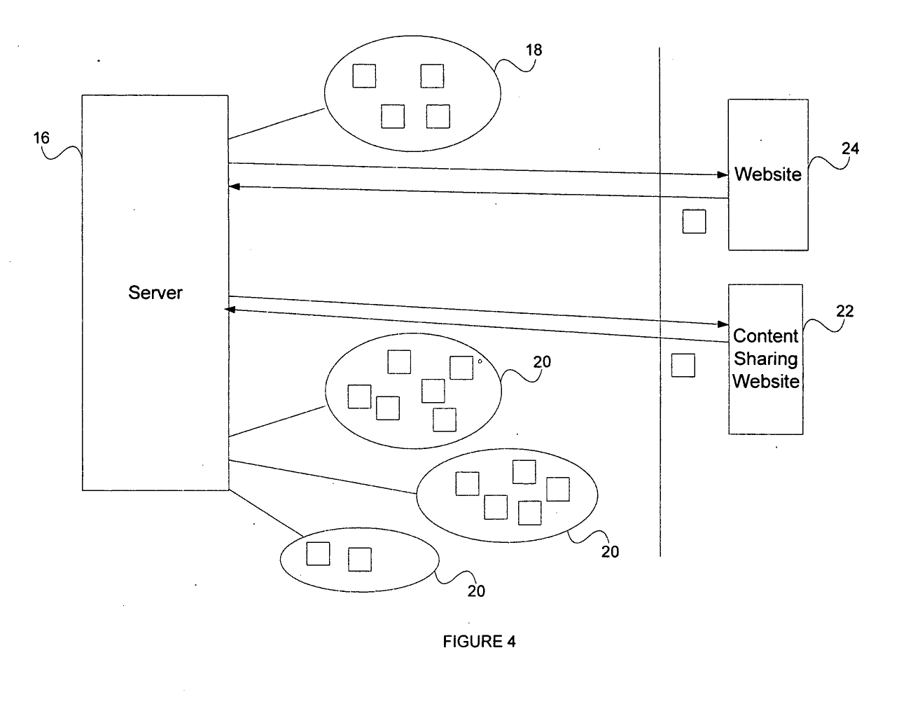

It may not be desirable for the returned image-results to be dominated by a particular standalone website or a particular content group, even if the tag-specific ranking indicates the particular standalone website or the particular content group has a high level of relevance to the image-search. Limiting each originating site to a single representative image may yield more satisfactory image-search results for the user. FIG. 4 illustrates limiting the image-search results from each originating site to a single image in accordance with one embodiment of the present invention. The server system 16 is configured such that image-search results from each originating site 22 and 24 are limited a single image where each originating site is limited to a single image, regardless of the number of images which have a high tag-specific ranking in the particular standalone website or the particular content-sharing website. In this embodiment, the returned image-search results will not be dominated by either websites 22 and 24.

In another embodiment, the server system 16 is programmed so that each content group 20 within a content sharing website 22 is limited to returning a single image for any particular image-search. This allows a number of content groups 20 in a particular content-sharing website 22, all of which may have a high degree of relevance to a particular image-search, maintain representation in the returned image-results.

In yet another embodiment, the server system 16 provides a link with the returned image-search results enabling an option to preview additional images from the originating site 18 and 20 associated with each of the returned images. In yet another embodiment, the server system 16 identifies and eliminates duplicate images from the returned image-search results.

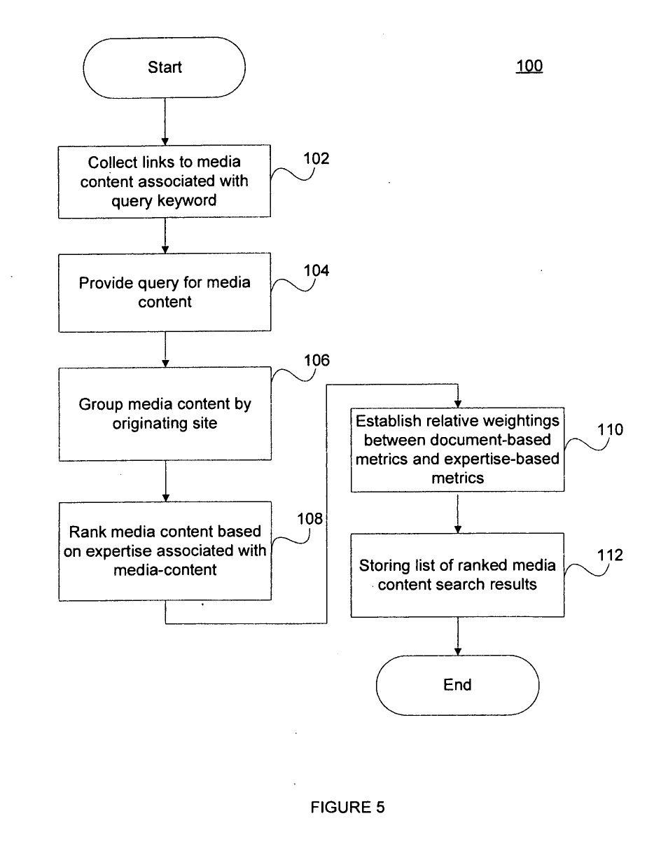

FIG. 5 is flow chart diagram illustrating process operations for generating a list of ranked media-content search results in accordance with one embodiment of the present invention. Examples of media-content may include, but are not limited to, video, audio, or image files. The method 100 is initiated with operation 102, in which links to media-content from a plurality of sources is collected. As illustrated in FIG. 1, the server system is linked to a number of originating sites consisting of either standalone websites or content-sharing websites through the Internet. The method 100 then advances to operation 104 in which the server system receives a query for media-content using a keyword. Operation 106 groups the plurality of media-content from each of the plurality of sources by originating site. In one embodiment, each content group in each content-sharing website is considered a separate source of media-content and each source of media-content receives a tag-specific ranking.

In operation 108, each grouping of media-content is ranked based on the expertise associated with each grouping of media-content. In one embodiment, the expertise of each grouping of media content is judged based on quality-based metrics and external-based metrics. The quality-based metrics are defined by one or more of calculating the percentage of media-content associated with the keyword, the quality of the media-content, and the relevance of the text on the webpage associated with the keyword, as shown in FIG. 3. Referring to FIG. 1, the quality-rank module calculates the percentage of media-content associated with the keyword using the query by image content (QBIC) system. The QBIC system is based a prototype system with two major steps: database population and query. In database population, methods identify objects in still images, segment videos into short sequences called shots, and compute features describing color, texture, shape, position, or motion information. In database query, images and shots can be retrieved by example or by selecting properties from pickers such as a color wheel, a sketched shape, a list of camera motions, or a combination of these. Further details on the QBIC system may be found in “Query by Image and Video Content” by Myron Flickner et al., Computer, Sep. 1995, pages 23-32. This article is incorporated by reference for all purposes.

In another embodiment, the quality-rank module measures the quality of media-content for audio and video files based on one or more of the bitrate of the media-content or whether the media-content is encoded using lossy or lossless format. Media-content encoded using a higher bitrate or using lossless format would indicate a higher quality media-content and hence higher value in a media-content search.

The method 100 then moves to operation 110, which establishes a relative weighting between external-based metrics and quality-based metrics for each grouping of media-content. As shown in FIG. 1, the tag-specific rank module takes input from the external-rank module and the quality-rank module to calculate the tag-specific ranking for each grouping of media-content. In one embodiment, the results from the external-rank module and the quality-rank module are added together to calculate the tag-specific ranking for each group of media-content. In another embodiment, user input is used to update the relative weighting of external-based metrics and quality-based metrics, training a machine-learning algorithm to improve user satisfaction with media-content searches.

In operation 112, a list of ranked media-content search results are stored in the server system. The media-content search results are based on the tag-specific ranking determined by the tag-specific rank module using external-based metrics and quality-based metrics.

The invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of generating a list of ranked media-content search results stored in memory, comprising:
collecting a plurality of links to a plurality of media-content from a plurality of sources through the Internet;
receiving a query for media content using a keyword;
grouping the plurality of media-content from each of the plurality of sources by an originating site, wherein the plurality of media-content from each originating site receives a tag-specific ranking;
ranking each grouping of the plurality of media-content based on an expertise of each grouping of the plurality of media-content;
calculating a tag-specific ranking based on the expertise of each grouping of the plurality of media-content; and
storing the list of ranked media-content search results based on the tag-specific ranking of each grouping of media-content.

2. The method of generating the list of ranked media-content search results of claim 1, calculating a tag-specific ranking further comprising:
establishing a relative weighting between external-based metrics and quality-based metrics for each of grouping of media-content.

3. The method of generating a list of ranked media-content search results of claim 1, further comprising:
eliminating duplicate media-content from the plurality of media-content search results.

4. The method of generating a list of ranked media-content search results of claim 2, wherein the tag-specific ranking based on external-based metrics and quality-based metrics is a multiplicative model.

5. The method of generating a list of ranked media-content search results of claim 2, wherein relative weighting of external-based metrics and quality-based metrics is updated using a plurality of input from a plurality of users to train a machine-learning algorithm.

6. The method of generating a list of ranked media-content search results of claim 1, further comprising:
considering each of a plurality of content groups in a content-sharing site as a separate source.

7. The method of generating a list of ranked media-content search results of claim 1, further comprising:
limiting search media-content results from each originating site to a single media-content file, wherein the single media-content file has the highest tag-specific ranking.

8. The method of generating a list of ranked media-content search results of claim 1, further comprising:
providing a link with the option to preview additional media-content from the originating site associated with the single media-content file.

9. The method of generating a list of ranked media-content search results of claim 1, wherein media-content is defined to include digital images.

10. A computer readable media including program instructions providing a list of ranked image-search results stored in memory, comprising:
program instructions for receiving a query for an image using a keyword;
program instruction for collecting a plurality links to a plurality of images associated with the keyword from a plurality of sources through the Internet;
program instructions for consolidating the plurality of images from each of the plurality of sources into a plurality of clusters of images, wherein each cluster of images from each of the plurality of sources receives a tag-specific ranking;
program instructions for ranking each cluster of images based on external-based metrics and quality-based metrics;
program instructions for determining a relative weighting between external-based metrics and quality-based metrics for each cluster of images;
program instructions for integrating rankings from external-based metrics and quality-based metrics for each cluster of images to determine a tag-specific ranking; and
program instructions for storing the list of ranked image search results on a server system, wherein the plurality of image-search results are based on the tag-specific ranking of each cluster of images.

11. The computer readable media of claim 10, further comprising:
program instructions for defining quality-based metrics includes one or more of analyzing the plurality of images of each grouping associated with the keyword, analyzing a quality of each cluster of images, and tracking a number of user click-throughs to the each cluster of images.

12. The computer readable media of claim 11, wherein the quality of the plurality of images includes one or more of measuring sharpness, histogram equalization, and the compression ratio of each cluster of images.

13. The computer readable media of claim 10, further comprising:
program instructions for analyzing each of a plurality of content groups in a content-sharing site as a separate source, wherein the tag-specific ranking is calculated for each of the plurality of content groups.

14. The computer readable media of claim 10, further comprising:
program instructions for representing image-search results with a single image for each of a plurality of sources, wherein the single image has the highest tag-specific ranking; and
program instructions for providing a link with the option to preview additional images from the originating site associated with the single image.

15. The computer readable media of claim 10, further comprising:
program instructions for calculating the tag-specific ranking as a non-linear function of the quality-metrics and the expertise-metrics.

16. The computer readable media of claim 10, wherein the relative weighting of document-based metrics and expertise-based metrics is determined using machine-learning techniques, wherein relative ranking yields the best match of the tag-specific ranking with human-judgments of quality of the image search.

17. The computer readable media of claim 10, further comprising:
program instructions for eliminating duplicate images from image-search results.

18. A system for generating relevant image searches comprising:
a server system in communication with the client system through an Internet connection, the server system receiving an image search query, the server system collects a plurality of links to a plurality of images associated with the keyword from a plurality of sources through the Internet; the server system consolidates the plurality of images from each of the plurality of sources into a plurality of group of images and each of the plurality of groups of images receives a tag-specific ranking, the server system includes a external-rank module ranking each group of images based on external-based metrics, the server system includes a quality-rank module ranking each group of images based on expertise-based metrics, wherein the quality-rank module produces rankings based on one or more of calculating a percentage of the plurality of images of each grouping is associated with the keyword, quality of the plurality of images, and relevancy of the text associated with the plurality of images to the keyword, the server system includes a tag-specific rank module to compute a tag-specific ranking for each group of images using results from the external-rank module and the quality-rank module, the server system provides image search results based on the tag-specific ranking of each grouping of images to a display of the client system.

19. The system of claim 18, wherein the quality-ranking module of the server system analyzes the text associated with each of the plurality of images associated with the keyword.

20. The system of claim 18, wherein the tag-specific rank module calculates a relative weighting of external-based metrics and quality-based metrics by adding results from the external-rank module and the quality-rank module.
